(19) United States
(12) Patent Application Publication
(10) Pub. No.: US 2007/0101547 A1
(43) Pub. Date: May 10, 2007

(54) Tool handle with finger positioning guide

(76) Inventor: James J. Egeland, Blaine, MN (US)

Correspondence Address: CLAUDE T. ANDERSON, 1758 VENUS AVE, ARDEN HILLS, MN, 55112, US

(21) Appl. No.: 11/270,260

(22) Filed: Nov. 9, 2005

(51) Int. Cl. B25G 1/10

(52) U.S. Cl. 16/430

(57) ABSTRACT

A new tool handle for providing an improved control, accuracy and stability for use with striking tools such as hammers of various types as well as multipurpose tools such as hatchets. The inventive device includes a shaft, a thumb ramp, a finger shield fixedly attached to the shaft and a finger positioning guide attached to the finger shield. The finger shield serves to physically restrain the tool in event of a loss of grip during use. The finger positioning guide allows a grip for a hand position for improved accuracy and control of the tool during helpful particularly with individuals having a weak hand grip or impaired freedom of finger movement.

### CROSS REFERENCE TO RELATED APPLICATIONS

(Not Applicable)

### STATEMENT OF FEDERALLY SPONSORED RESEARCH/DEVELOPMENT

(Not Applicable)

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

(Not Applicable)

### BACKGROUND OF THE INVENTION

The present invention relates to hand tools generally and more particularly pertains to a new tool handle for providing an improved grip as well as improved accuracy and control. The tool handle may be utilized with a variety of hand tools such as with garden tools such as a hand cultivator or hoe, contractor/home repair tools such as hammers of various types, as well as multipurpose tools such as hatchets. The present application provides for the improvement of including a finger positioning guide to the tool handle disclosed in U.S. Pat. No. 6,009,600 by Egeland, et al. dated Jan. 4, 2000, which hereby is incorporated by reference.

The finger positioning guide feature of the handle located on the front of the finger shield describes a feature on the outside of the finger shield wherein a tool user may place their index finger into a depression on the finger shield that will accept and support the index finger. The finger positioning guide adds accuracy and additional control lessening the chances of missing the object the user is striking. This is very important for a person with only a limited amount of strength, or for someone who may be tired where every strike is important and particularly when working on finished surfaces where missed strikes may cause damage to the adjacent surface.

The use of hand tools is well known in the prior art. A hand tool generally consists of the tool head and a fixed handle. The present invention relates to an improved handle and is particularly beneficial for use with handles for striking tools. For many years, various modifications have been made to striking tool handles to improve the grip characteristics. More specifically, the use of hammers to drive fasteners such as nails has been known to consist basically of familiar, expected and obvious structural configurations, notwithstanding the myriad of designs encompassed by the crowded prior art which have been developed for the fulfillment of countless objectives and requirements.

Known prior art handles for tools include U.S. Pat. No. 4,613,156 by Lajos, U.S. Pat. No. 4,934,024 by Sexton; U.S. Pat. No. 5,692,265 by Dalury; and U.S. Pat. No. 5,588,343 by Rust et al.

It must be understood that previous hand tool handles do not have the features of the present invention. U.S. Pat. No. 4,613,156 by Lajos, discloses a ski pole handle with finger grooves on a gripping surface interior to the finger shield.

U.S. Pat. No. 4,934,024 by Sexton describes a process for making a moldable plastic handle designed to conform to the user's hand. This process produces a unique tool handle having finger grooves on the tool shaft that is customized for one user.

U.S. Pat. No. 5,692,265 by Dalury illustrates an ergometric handle to increase comfort and control over a hand tool. Although the handle provides finger grooves and a thumb indentation, it does not disclose a finger shield with a finger positioning guide or a thumb ramp designed to position the user's thumb so that it is balanced axially above the centerline of the handle.

U.S. Pat. No. 5,588,343 by Rust et al. describes a composite handle providing an improved grip utilizing synthetic plastic compounds that include grooves along the handle shaft to enhance gripping. Rust does not disclose a finger shield with a finger positioning guide.

While these devices fulfill their respective, particular objectives and requirements, the aforementioned patents do not disclose a new tool handle for use on striking tools that has a shaft, thumb ramp, finger shield and a finger positioning guide located on the finger shield.

Conventional handles can be constructed from various materials such as wood, steel, fiberglass, plastic or composites consistent with the specific intended application for a particular tool head. However, conventional prior art handles suffer from a number of deficiencies. Hand tools are often used in environmental extremes that range from dry to wet as well as hot to cold. In wet or hot conditions, a hammer handle can become wet making it slippery and difficult to hold on to. Since normal use often requires swinging hand tools with a good deal of force unintentional loss of grip while using a conventional handle often results in the tool becoming an out-of-control flying projectile creating a potentially dangerous situation.

Furthermore, there are large numbers of elderly individuals or persons with nerve or muscular problems or other physical limitations or physical characteristics, such as having a small body frame, that result in their having a weak handgrip. For these individuals obtaining a good grasp on a conventional handle is difficult to impossible even under ideal conditions. These individuals may have adequate upper body strength for using hand tools, while being unable to utilize a hand tool because of the concern over losing their handgrip while swinging the hand tool, creating a potentially dangerous situation.

Furthermore, a conventional tool handle requires the users hand to be wrapped around the shaft with all fingers forming along the shaft diameter at the grip area which is generally fairly narrow. Since individuals with compromised hand strength may have limited finger/hand movement and may not be able to form the required small diameter grip, or if able to form the grip, it may be of an insufficient clasping strength to be able to utilize the hand tool. Providing an alternative holding position wherein the index finger does not have to be flexed to reach the handle shaft surface, but rather can clasp the handle on the finger shield at a finger positioning guide, allowing a holding position that would have allow a firmer hold of the tool handle for these users. In addition, the finger positioning guide is shaped to accept and cradle the index finger, providing a physical surface to prevent slippage of the hand along the hand tool handle, in addition to the frictional resistance present in the hand grip itself. Further, the wider stance allowed for the index finger with the finger positioning guide, allows greater accuracy and control of the tool handle during use of the tool.

Independently of the limitations of maintaining a hold of the grip, a second limitation arises for conventional shaped tool handles. Prior art handles are designed to orientate the individual user's thumb to wrap around the user's fingers to further secure the grip. With the user's thumb substantially parallel to the user's fingers, all side to side control of the hammer is substantially provided by the palm of the user's hand. Since the thumb is unavailable to provide side to side control, loss of control can occur. This can result in meaning of the work surface or even a bruised thumb or finger when the user is holding a nail to start it and inadvertently hits a finger while trying to start the nail.

In these respects, the tool handle according to the present invention substantially departs from the conventional concepts and designs of the prior art, and in so doing provides an apparatus primarily developed for the purpose of providing a substantially improved tool handle for use with striking tools.

### BRIEF SUMMARY OF THE INVENTION

In view of the foregoing disadvantages inherent in the known types of tool handles for use on a striking tool now present in the prior art, the present invention provides a new tool handle for use on a string tool herein the same can be utilized for providing an improved grip during use.

The present invention generally comprises a shaft, a thumb ramp, a finger positioning guide and a finger shield. The present invention provides an alternative to the typical ‘clenched fist’ grasp required for a convention tool handle. The finger positioning guide located on the front of the finger shield provides a feature wherein a tool user may place their index finger on the outside of the finger shield. The feature adds accuracy and additional control lessening the chances of missing the object the user is striking. This is very important for a person with only a limited amount of strength, limited amount of finger dexterity or mobility and or for someone who may be tired where every strike is important and particularly when working on finished surfaces where missed strikes may cause damage to the adjacent surface.

It is therefore an object of the present invention to provide a new tool handle for use which has many of the advantages of tool handles mentioned heretofore and several novel features that result in a new tool handle for use on a tool which is not anticipated, rendered obvious, suggested, or even implied by any of the prior art tool handles, either alone or in any combination thereof.

Still yet another object of the present invention is to provide a new tool handle which provides in the apparatuses of the prior art some of the advantages thereof, while simultaneously overcoming some of the disadvantages normally associated therewith.

It is another object of the present invention to provide a new tool handle which may be safely used in the hand of an individual with a weak grip, due to handicap, disease such as arthritis, fatigue or other reasons which will provide an alternative grip to the small diameter hand clasp for a convention tool handle, with a grip in which the index finger is placed in a wider diameter clasp than the remaining fingers to achieve greater control and accuracy.

It is another object of the present invention to provide a new tool handle with greatly reduced risk of unintentional release while swinging the tool.

It is another object of the present invention to provide a new tool handle in which the thumb of the individual user may be effectively utilized to provide increased accuracy and control of the tool during use.

It is another object of the present invention to provide a new tool handle in which the thumb of the individual user may be effectively utilized to provide increased accuracy and control of the tool during use, particularly for an individual who is inexperienced in the use of the tool, or has a weak grip, as a result of age, handicap, disease, fatigue or other reasons.

It is another object of the invention to provide a new tool handle that may be used as a component of an interchangeable hand tool system, wherein the handle may be quickly attached and removed from a variety of tool heads.

It is another object of the invention to provide a new tool handle that is equally suited for use by right-handed and left-handed individuals.

It is another object of the invention to provide a new tool handle that can be manufactured from hardwoods, cast and extruded metals, molded plastics, fiberglass and epoxy resins or composite materials such as polypropylene plastic over a fiberglass core.

It is another object of the present invention to provide a new tool handle which may be easily and efficiently manufactured and marketed.

It is a further object of the present invention to provide a new tool handle which is of a durable and reliable construction.

An even further object of the present invention is to provide a new tool handle which has a low cost of manufacture with regard to both materials and labor, and which accordingly is then susceptible of low prices of sale to the consuming public, thereby making such tool handle economically available to the buying public.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING

The invention will be better understood and objects other than those set forth above will become apparent when consideration is given to the following detailed description thereof. Such description makes reference to the annexed drawings wherein:

FIG. 1 is a side elevation view of the tool handle according to the present invention.

FIG. 2 is a bottom plan view of the finger positioning guide side of the present invention.

FIG. 3 is a top plan view of the thumb ramp side of the present invention.

FIG. 4 is a cross sectional view taken along line 4-4 of FIG. 1.

FIG. 5 is an elevational side view of the present invention showing hand position during use of the finger positioning guide.

FIG. 6 is an elevational side view of the present invention showing an alternative hand position.

FIG. 7 is a side elevation view of an alternative embodiment of the tool handle

FIG. 8 is a top plan view of the thumb ramp side of an alternative embodiment of the tool handle

FIG. 9 is a bottom plan view of the finger positioning guide side of an alternative embodiment of the tool handle.

FIG. 10 is an end elevation view of the base of the tool handle

FIG. 11 is a top plan view of the tool handle with a garden spade head attachment.

FIG. 12 is a side elevation view of the tool handle with a garden spade head attachment.

FIG. 13 is a top plan view of the tool handle with a garden cultivator head attachment.

FIG. 14 is a side elevation view of the tool handle with a garden cultivator head attachment.

### DETAILED DESCRIPTION OF THE INVENTION

With reference now to the drawings, a new tool handle embodying the principles and concepts of the present invention and generally designated by the reference numeral 10 will be described. Materials of construction for the tool handle typically include select hardwoods, cast and extruded metals, molded plastics, fiberglass and epoxy resins.

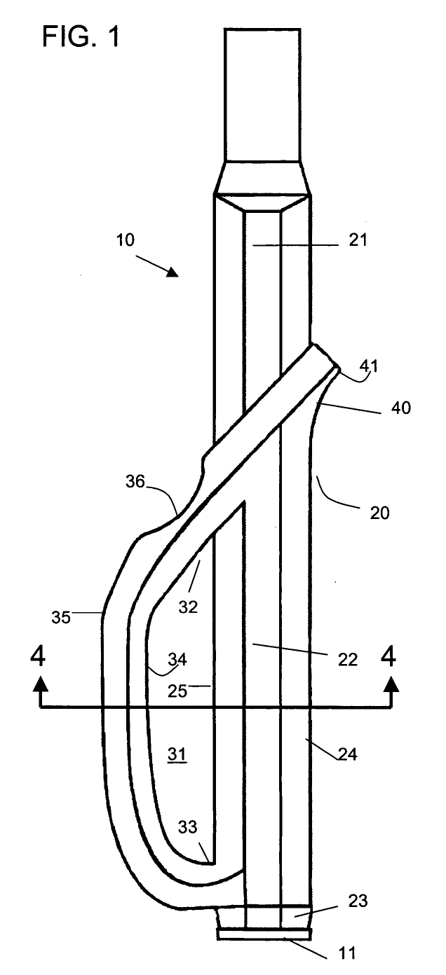

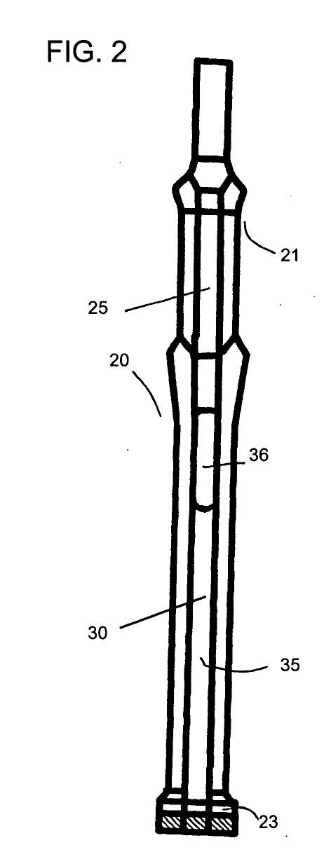

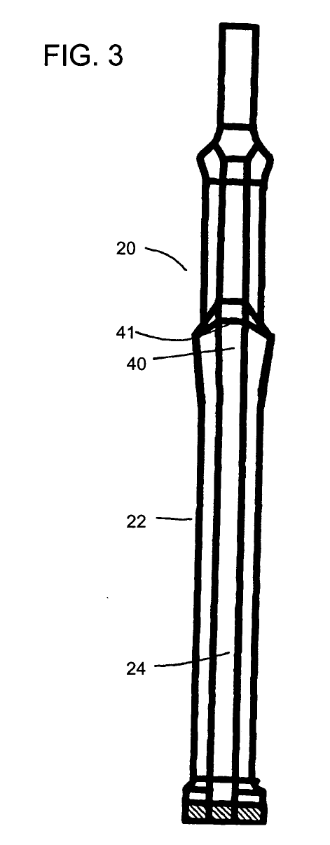

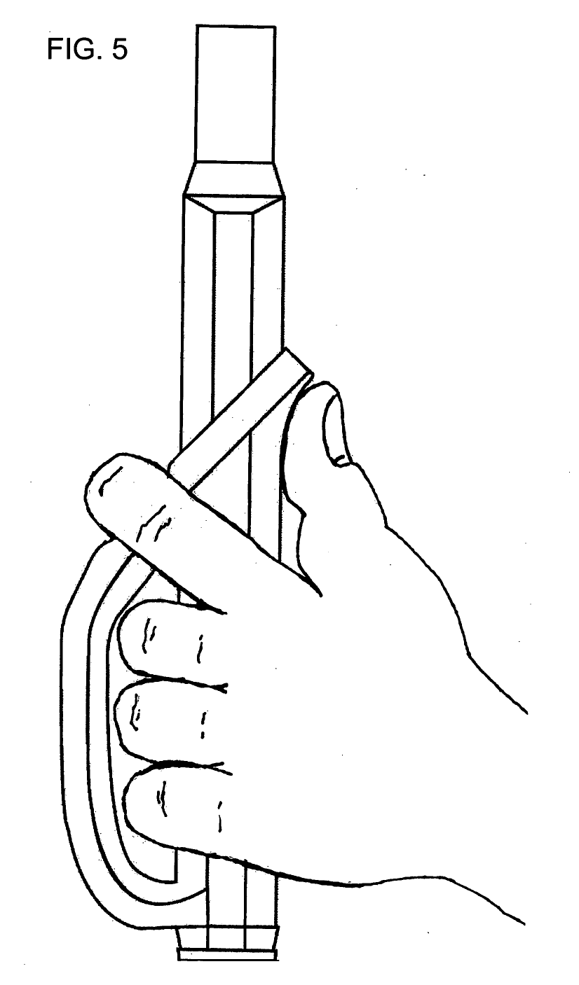

More specifically, with reference to FIG. 1 and FIG. 5 it will be noted that the tool handle (10) comprises a shaft (20), a finger shield (30) and a thumb ramp (40). The shaft (20) is composed of a grip portion (22), a head end (21) and a free end (23). The grip portion (22) is disposed between the head end (21) and free end (23). The head end (21) is adapted to receive a tool head (50) with a striking surface (51). The shaft further having an upper shaft surface (24) and a lower shaft surface (25). The lower shaft surface (25) as shown in FIG. 2 is substantially parallel to the striking surface (51) and is positioned on the same side of the tool handle (10) as the striking surface (51). The upper shaft surface (24) as shown in FIG. 3, is immediately adjacent and adjoined to the lower shaft surface (25). The upper shaft surface (24) is on the opposite side of the tool handle (10) as the lower shaft surface (25). The thumb ramp (40) being of sufficient size to support the user's thumb, is placed on the upper shaft surface (24) between the grip portion (22) and the head end (21). The thumb ramp (40) includes a thumb ramp apex (41) formed above the shaft (20). The thumb ramp (40) is positioned to provide a comfortable surface adequate to place the user's thumb. The finger shield (30) is fixedly attached to the lower shaft surface (25), substantially opposite the thumb ramp (40).

The finger shield (30), having a generally arcuate shape sized to allow free passage of a users hand in the preferred embodiment has an interior surface (34) an exterior surface (35) and a finger positioning guide (36). The interior surface (34) and the exterior surface (35) attaching to the interior surface (24) positioned to form a hand passage (31) with the lower shaft surface (25). The hand passage (31) being large enough to accommodate free passage of the user's fingers and palm. The finger shield (30) further having a forward hand lock (32) and a rearward hand lock (33). The forward hand lock (32) is located on the lower shaft surface (25) adjacent to the head end (21). The rearward hand lock (33) is located adjacent to the free end (23) of the shaft (20).

The finger positioning guide (36) is located on the exterior surface (35) of the finger shield (30) nearest the head end (21) of the shaft (20). The finger positioning guide (36) has a generally arcuate shape sized to accept and cradle a user's forefinger. The finger positioning guide (36) provides a feature that allows the user's index finger to contact the tool handle (10) in a grasp of a larger diameter than the grasp of the other fingers of the hand around the grip portion (22) of the shaft itself. The finger shield (30) has an interior surface (34) and an exterior surface (35), the interior surface forms a hand passage (31) between the finger shield (30) and the grip portion (22) sized to allow passage of the user's hand. The interior surface (34) of the finger shield (30) has a rearward hand lock (33) located on the grip portion (22) of the shaft adjacent to the free end (23), the finger shield (30) also has a forward hand lock (32) being positioned on the grip portion (22) adjacent to the head end (21) of the shaft, the forward hand lock (32) being tapered to receive the index finger or forefinger of the user; and a finger positioning guide (36) integral with the exterior surface (35) of the finger shield (30) adjacent the head end (21) of the shaft (20). The finger positioning guide (36) has an arcuate shape sized to accept and support the forefinger of the user.

A bumper pad (11) can be fixedly attached to the free end (23). The bumper pad (11) is generally composed of a resilient plastic or rubber material to allow positioning a work object by lightly tapping with the tool handle free end (23) without marring the surface of the work object.

The size of the shaft (20), finger shield (30), finger positioning guide (36) and the thumb ramp (40) can be manufactured to correspond to varying hand sizes and tool applications. For instance, a tool handle designed for an individual with a small hand would have a correspondingly smaller finger shield (30), thumb ramp (40) and hand passage (31). Furthermore, other variations on the finger shield (30) with the finger positioning guide (36) are possible.

In use, a tool head (50) such as a hammer head or hatchet head is fixedly attached to the head end (21) of the shaft. When the hand tool is swung, the striking surface (51) of the tool head (50) is substantially parallel with the lower shaft surface (25). With reference to FIG. 5, the finger shield provides the rearward hand lock (33) serving to help keep the tool handle (10) from accidental release by providing an additional independent mechanism for protection against loss of grip, above and beyond the normal friction between the hand and the shaft (20). As FIG. 5 shows, the finger shield provides the support for the finger positioning guide (36) which serves to position and stabilize the user's index finger on the tool handle. FIG. 5 further shows the position of the thumb located on the thumb ramp (40) to provide for additional control and accuracy during use. The thumb position along the upper shaft surface (24) allows additional control against side to side movement of the tool handle beyond what is available from the hand grip alone. In the present invention, the thumb is not merely supplementing the tightness of the grip by wrapping around the user's other fingers. Instead, the thumb is axially positioned along the shaft (20) on the thumb ramp (40), allowing subtle pressure with the user's thumb to directly affect control and stability of the tool handle (10).

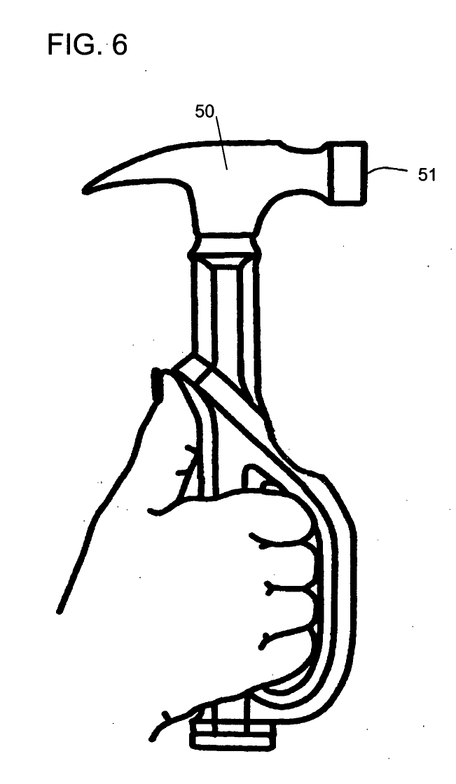

FIG. 6 shows a hand position when the finger positioning guide (36) is not in use. With reference to FIG. 6, the user's fingers are substantially protected by the finger shield (30). The rearward hand lock (33) serves to help keep the tool handle (10) from accidental release by providing an additional independent mechanism for protection against loss of grip, above and beyond the normal friction between the hand and the shaft (20). As FIG. 6 shows, the forward hand lock (32) serves to position and stabilize the user's hand on the tool handle. FIG. 6 further shows the position of the thumb located on the thumb ramp (40) to provide for additional control and accuracy during use. The thumb position along the upper shaft surface (24) allows additional control against side to side movement of the tool handle beyond what is available from the hand grip alone. In the present invention, the thumb is not merely supplementing the tightness of the grip by wrapping around the user's other fingers. Instead, the thumb is axially positioned along the shaft (20) on the thumb ramp (40), allowing subtle pressure with the user's thumb to directly affect control and stability of the tool handle (10).

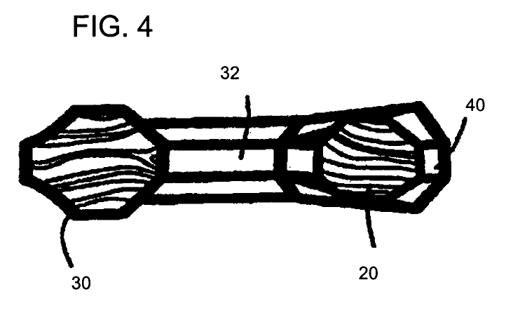

As shown in FIGS. 1-5, the tool handle (10) is symmetrical from side to side. Therefore, each tool is equally well suited for use by left-handed or right-handed individuals.

The prior art discloses a tremendous variety of weights, shapes and forms for the striking tool head depending on the intended application of the tool. The tool handle could be readily adapted to serve as part of a multi-use tool system. A number of tool heads could be designed to be compatible with the tool handle in an interchangeable system wherein the tool head could be quickly and easily attached and detached from the tool handle providing the benefits of the handle to a number of tools at relatively low cost. Typically, the finger shield (30) and thumb ramp (40) would be a of a rigid or semi-rigid structure, and be composed of one or more of the materials of construction used for the tool handle (10). However, depending on the application of the string tool, it may be preferable to utilize different materials for constructing the shaft (20), then used in the finger shield (30) or thumb ramp(40) of the tool handle (10).

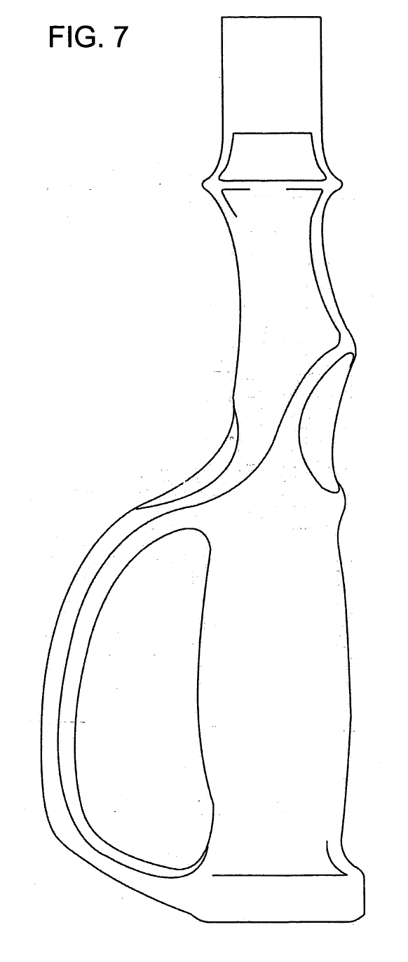

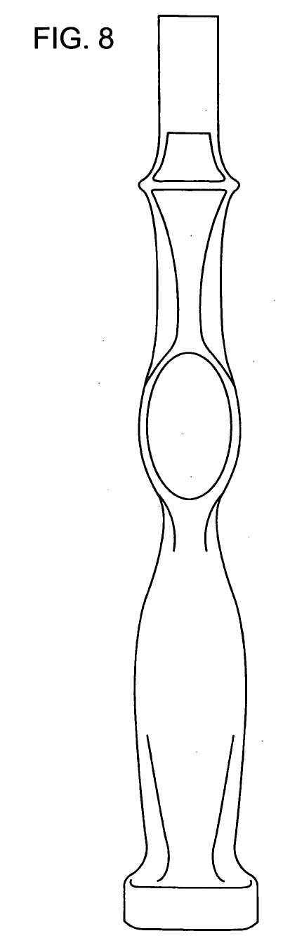

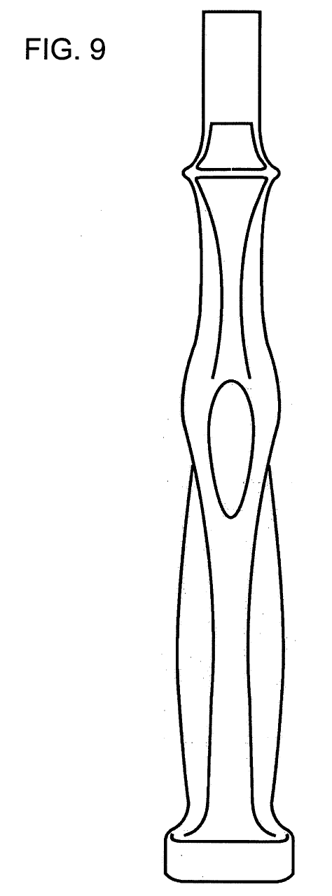

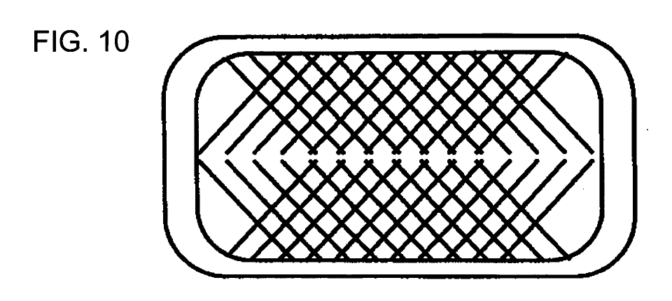

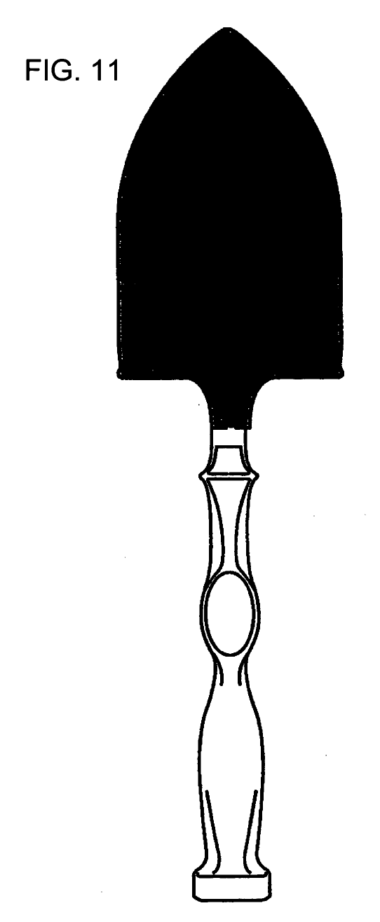

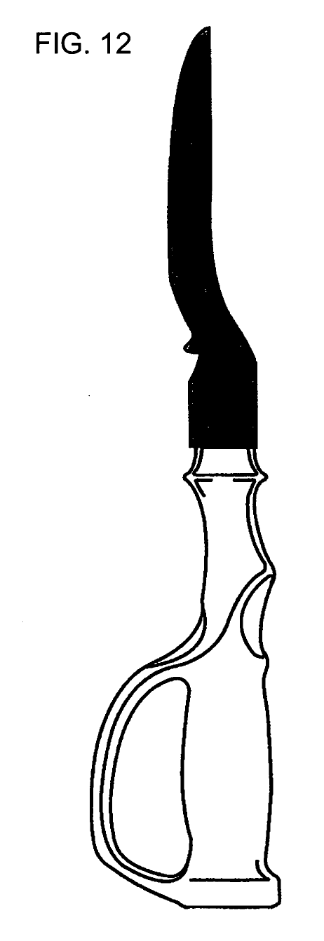

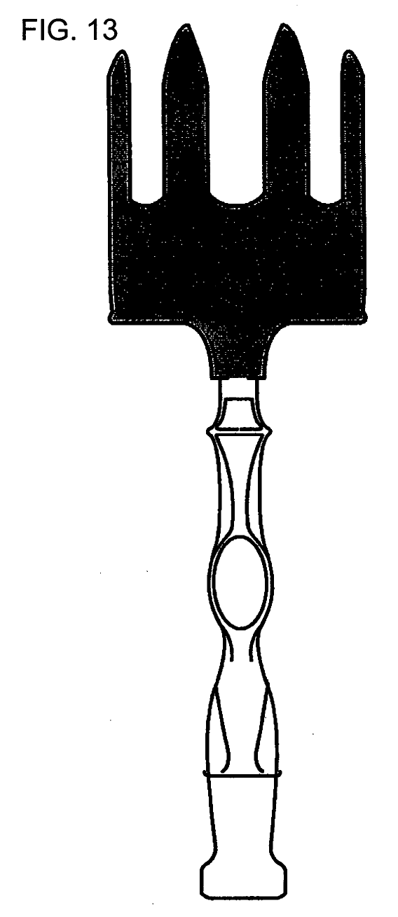

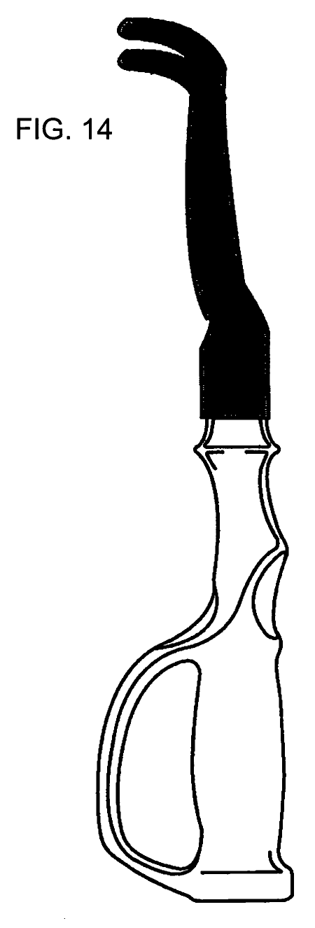

FIGS. 7-10 show various views of the present invention in an alternative embodiment of a less angular design. The alternative embodiment may provide cost savings in production of the invention. FIGS. 11-14 show the tool handle with garden tool attachments. FIGS. 11 and 12 show views of a garden hand spade with FIGS. 13 and 14 showing views of a garden cultivator hand tool.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A tool handle for use with a tool head comprising:
a shaft having a head end adapted to receive the tool head, a free end, and a grip portion, the grip portion being adjacent to the head end and the free end;
a finger shield fixedly attached to the shaft, the finger shield having an interior surface and an exterior surface, the interior surface forming a hand passage between the finger shield and the grip portion; the interior surface of the finger shield having a rearward hand lock being positioned on the grip portion adjacent to the free end, the interior surface of the finger shield further having a forward hand lock being positioned on the grip portion adjacent to the head end, the forward hand lock being tapered to receive the forefinger of the user; and
a finger positioning guide integral with the exterior surface of the finger shield adjacent the head end of the shaft, the finger positioning guide sized to accept and support the forefinger of the user.

2. The tool handle of claim 1 further comprising a thumb ramp fixedly attached to the shaft substantially near the transition between the grip portion and the head end.

3. The tool handle of claim 2 wherein the shaft further comprises an upper shaft surface and a lower shaft surface, the upper shaft surface being immediately adjacent and enjoined to the lower shaft surface.

4. The tool handle of claim 3 wherein the thumb ramp is located on the upper shaft surface.

5. The tool handle of claim 4 wherein the finger shield is located on the lower shaft surface.

6. A tool wherein the tool handle of claim 5 is attached to a garden hand cultivator head.

7. A tool wherein the tool handle of claim 5 is attached to a hammer head.

8. A tool wherein the tool handle of claim 5 is attached to a claw hammer head.
